(19) United States
(12) Patent Application Publication
(10) Pub. No.: US 2005/0237340 A1
(43) Pub. Date: Oct. 27, 2005

(54) Image processing apparatus, image processing method, image display apparatus, portable information device, control program and computer-readable recording medium

(75) Inventors: Satoshi Ueno, Nara (JP); Yasuhiro Yoshida, Chiba (JP); Hiroyuki Furukawa, Chiba (JP)

Correspondence Address: BIRCH STEWART KOLASCH & BIRCH, PO BOX 747, FALLS CHURCH, VA, 22040-0747, US

(73) Assignee: Sharp Kabushiki Kaisha, Osaka (JP)

(21) Appl. No.: 11/047,712

(22) Filed: Feb. 2, 2005

(30) Foreign Application Priority Data
Feb. 3, 2004 (JP) 2004-027398

(51) Int. Cl. G09G 5/02

(52) U.S. Cl. 345/600

(57) ABSTRACT

An image processing apparatus includes a selection section for selecting and retrieving a significant part in terms of resolution from a bit steam of an image signal which is input to each pixel of an image display apparatus; and an extension and correction section for extending and correcting the significant parts of the image signals selected by the selection section in a low-frequency part which includes a plurality of consecutive image signals having a first signal value and a plurality of consecutive image signals having a second signal value which is different from the first signal value by a prescribed value, wherein the significant parts are each extended and corrected by being supplemented with a prescribed number of bits, such that the first signal value smoothly changes to the second signal value.

This non-provisional application claims priority under 35 U.S.C., §119(a), on Patent Application No. 2004-27398 filed in Japan on Feb. 3, 2004, the entire contents of which are hereby incorporated by reference.

### BACKGROUND OF THE INVENTION

1. Field of the Invention

The present invention relates to an image processing apparatus and method for correcting an image signal by estimating insignificant bit streams from significant bit streams of the image signal and replacing the insignificant bit streams with other data through calculations, an image display apparatus using the same, such as a liquid crystal display apparatus, a mobile information device using the same, such as a cellular phone device or a PDA, a control program for causing a computer to execute the image processing method, and a computer-readable recording medium having the control program recorded thereon.

2. Description of the Related Art

Recently, technologies for image display apparatuses, especially technologies for displaying images with high precision, have been improved. Today, it is possible to display precise CG (computer graphics) images and images of natural scenery with a high degree of reality. Still, there are increasing demands for image displaying apparatuses for displaying more precise images having a greater level of gradation than the images realized by the image displaying technologies achieved so far.

According to the currently mainstream technology of image display apparatuses using digital signals as image signals, 6 to 8 bits of digital data are assigned to each of R (red), G (green) and B (blue) color components. With the increasing demands for displaying more precise images having a greater level of gradation, there will be more demands for increasing the number of bits of digital signals in the future.

An image display apparatus by which 6 to 8 bits of digital data are assigned to each of R, G and B color components will be specifically described.

In such an image display apparatus, a 16-bit digital image data can display 65536 colors because 2¹⁶=65536. For displaying an RGB color image with such an image display data, a 5-6-5 format is generally used. According to the 5-6-5 format, 5 bits are assigned to R, 6 bits are assigned to G, and 5 bits are assigned to B, so as to provide a 16-bit digital image data.

In a TFT-type liquid crystal display panel unit, 6 bits are assigned to each of R, G and B as a gradation display value, so as to provide an 18-bit image display data. An image display data in correspondence with the input digital image data is output and processed.

In order to match the 18-bit image display data displayed by the TFT-type liquid crystal display panel unit and the 16-bit digital image data which is input to the TFT-type liquid crystal display panel to each other, gradation correction is performed for extending the digital image data of R pixels and B pixels each having 5 bits assigned thereto into a 6-bit image display data.

Such gradation correction is performed using (1) an LSB (Least Significant Bit) fixing method, (2) an MSB (Most Significant Bit) repeating method, or (3) a gradation palette method.

According to the LSB fixing method (method 1), 1 bit is added as the LSB to the 5-bit data to form 6-bit data. As the LSB, “1” or “0” is set automatically.

According to the MSB repeating method (method 2), 1 bit is added as the LSB to the 5-bit data to form 6-bit data. As the LSB, the same value as the MSB is set.

According to the gradation palette method (method 3), 5-bit data and 6-bit data are associated with each other in a palette referred to as a look-up table (LUT) or a conversion table. When a value of the 5-bit data is input, 6-bit data corresponding to the input value is output.

As a pseudo gradation method for increasing the number of levels of gradation of an image display apparatus, (4) a dither method, (5) an error diffusion method, and (6) an FRC (Frame Rate Control) method are generally known, for example.

The dither method (method 4) is performed as follows. Among the pixels included in a certain area and having reference signal values, the ratio of the pixels having different signal values (different frequencies of appearance) is found. In accordance with the ratio, a gradation level (intermediate level) between two reference signal values is displayed.

The error diffusion method (method 5) is performed as follows. An image signal value of a certain pixel is quantified (or binarized), and the difference between the quantified value and the original image signal value (quantification error) is apportioned to the signal values of the pixels around the certain pixel. Thus, a gradation level is displayed.

The FRC method (method 6) is performed as follows. Among the pixels included in a certain time period (e.g., 1 frame) and having reference signal values with respect to a certain pixel, the ratio of the time period in which different signal values are displayed is found. In accordance with the ratio, a gradation level (intermediate level) between two reference signal values is displayed.

The above-identified conventional methods (1) through (6) are described in Japanese Laid-Open Publications Nos. 1-282598, 6-35429, 6-222740, and 2003-44006.

Methods (1) through (3) have color reproducibility (color gradation reproducibility) problems, which will be described below. In the following description, the value “00h” of 5-bit digital image data and 6-bit image display data corresponds to the darkest display. The value “1Fh” of 5-bit digital image data and the value “3Fh” of 6-bit image display data correspond to the brightest display.

As described above, when the LSB fixing method (method 1) is used, 6-bit gradation correction (extension) of an original image may be performed by adding “0” as the LSB to a 5-bit digital image data (color component image display data) of the original image. In this case, the value “1Fh” corresponding to the brightest display is converted into “3Eh” in the 6-bit image display data. Thus, the liquid crystal display panel cannot provide the brightest display corresponding to the value “3Fh”. In the case where 6-bit gradation correction is performed by adding “1” as the LSB, the value “00h” corresponding to the darkest display is converted into the value “01h”. Thus, the liquid crystal display panel cannot provide the darkest display.

When 6-bit gradation correction is performed using the MSB repeating method (method 2), consecutive values, for example, “0Fh” and “10h” of a 5-bit digital image data are converted into “1Eh” and “21h” of the 6-bit image display data. Thus, a display of continuous brightness is not provided, and conspicuous discrete bright points are generated.

With the gradation palette method (method 3), once a palette associating 5-bit digital image data and 6-bit image display data is set, the same setting is used for all the images. This requires the palette to be re-set for each of the different types of images, for example, images of natural scenery, graphics images, and animation images. Such an operation imposes a high load on the user.

The problems presented by methods (1) through (3) are caused because the capability of the display panel to display a 6-bit data (26=64 gradation display) cannot be fully utilized. Methods (1) and (2), by which “0” or “1” is added automatically as the LSB, limit the display capability of the panel to 5-bit data display (25=32 gradation display). According to method (3), a palette can include only 32 types of data.

Due to the inability to fully utilize the display capability of the panel, methods (1) through (3) further have the following common problem. Since the number of bits of image signals is insufficient, a pseudo profile phenomenon may occur that a portion of an image of natural scenery which should be displayed with a smooth gradation change appears as stripes (profiles).

In addition, when the number of gradation bits of an image display apparatus is larger than the number of gradation bits of an input image signal, the gradation display capability of the image display apparatus cannot be fully utilized because the number of bits of the display is limited to the number of gradation bits of the input image signal.

Methods (4) through (6) can improve the gradation display capability of the image display apparatus when the number of gradation bits of the image display apparatus is smaller than the number of gradation bits of an input image signal, i.e., when the gradation display capability of the image display apparatus is inferior to the input image signal. By contrast, when the number of gradation bits of the image display apparatus is larger than the number of gradation bits of an input image signal, the gradation display capability of the image display apparatus cannot be fully utilized because, again, the number of bits of the display is limited to the number of gradation bits of the input image signal. For example, even when an 8-bit signal is input to an image display apparatus, only the upper 6 bits may be used as data for the reason that the lower 2 bits have constants or noise (i.e., only the upper 6 bits are significant in terms of resolution). In such a case, even if the image display apparatus is capable of displaying an 8-bit data, an image only corresponding to a 6-bit data can be displayed. When the lower 2 bits have noise caused by an error or the like, the image quality is deteriorated.

### SUMMARY OF THE INVENTION

According to one aspect of the invention, an image processing apparatus includes a selection section for selecting and retrieving a significant part in terms of resolution from a bit steam of an image signal which is input to each pixel of an image display apparatus; and an extension and correction section for extending and correcting the significant parts of the image signals selected by the selection section in a low-frequency part which includes a plurality of consecutive image signals having a first signal value and a plurality of consecutive image signals having a second signal value which is different from the first signal value by a prescribed value. The significant parts are each extended and corrected by being supplemented with a prescribed number of bits, such that the first signal value smoothly changes to the second signal value.

In one embodiment of the invention the extension and correction section includes a detection section for detecting the low-frequency part which includes the plurality of consecutive image signals having the first signal value and the plurality of consecutive image signals having the second signal value which is different from the first signal value by the prescribed value; and a signal extension section for extending and correcting the significant parts of the image signals in a prescribed range of the low-frequency part detected by the detection section. The prescribed range including at least either the plurality of consecutive image signals having the first signal value or the plurality of consecutive image signals having the second signal value. The significant parts of at least either the plurality of consecutive image signals having the first signal value or the plurality of consecutive image signals having the second signal value are each extended and corrected by being supplemented with a prescribed number of bits, such that the first signal value smoothly changes to the second signal value.

In one embodiment of the invention the detection section includes a signal value comparison section for comparing signal values corresponding to a series of adjacent pixels and determining whether or not the signal values are equal to each other; an image position memory section for, when the signal value comparison section determines that the signal values are equal to each other, storing position information on a position of the first pixel of the series of adjacent pixels corresponding to the same signal value; and a width memory section for, when the signal value comparison section determines that the signal values are equal to each other, storing the number of the pixels of the series of adjacent pixels corresponding to the same signal value.

In one embodiment of the invention the detection section determines whether or not a given image signal is a subject of extension and correction by determining whether or not a distance between a position of the first pixel of a first series of adjacent pixels corresponding to the first signal value and a position of the first pixel of a second series of adjacent pixels corresponding to the second signal value is equal to the number of pixels of the first series of adjacent pixels.

In one embodiment of the invention when the detection section determines that the given image signal is not a subject of extension and correction, the signal extension section supplements the significant part of the given image signal with a prescribed number of bits having a value of an insignificant part of the input image signal and/or having a fixed value.

In one embodiment of the invention in the low-frequency part detected by the detection section, the first signal value is different from the second signal value by 1.

In one embodiment of the invention the extension and correction section performs extension and correction on image signals from the center of the plurality of consecutive image signals having the first signal value to the center of the plurality of consecutive image signals having the second signal value.

In one embodiment of the invention the extension and correction section performs extension and correction on image signals in a range which includes at least an image signal having the first signal value and an image signal having the second signal value, which are located before and after a point of change at which the first signal value changes to the second signal value.

In one embodiment of the invention the extension and correction section performs extension and correction on image signals such that the point of change at which the first signal value changes to the second signal value is the center of a bit stream to be extended and corrected.

In one embodiment of the invention the prescribed number of bits is two bits, three bits or four bits.

In one embodiment of the invention the signal extension section performs extension and correction such that the first signal value changes to the second signal value linearly or in a curved manner.

In one embodiment of the invention the plurality of consecutive image signals having the first signal value and the plurality of consecutive image signals having the second signal value are arranged in at least one of a horizontal direction in which the image signals are transmitted on an image display screen of the image display apparatus, a vertical direction perpendicular to the horizontal direction, and an oblique direction.

In one embodiment of the invention the significant part has a number of gradation bits which is smaller than the number of gradation bits of the image display apparatus.

According to another aspect of the invention, an image processing method includes the steps of selecting and retrieving a significant part in terms of resolution from a bit steam of an image signal which is input to each pixel of an image display apparatus; detecting a low-frequency part which includes a plurality of consecutive image signals having a first signal value and a plurality of consecutive image signals having a second signal value which is different from the first signal value by a prescribed value; and extending and correcting the significant parts of the image signals in a prescribed range of the low-frequency part. The prescribed range including at least either the plurality of consecutive image signals having the first signal value or the plurality of consecutive image signals having the second signal value. The significant parts of at least either the plurality of consecutive image signals having the first signal value or the plurality of consecutive image signals having the second signal value are each extended and corrected by being supplemented with a prescribed number of bits, such that the first signal value smoothly changes to the second signal value.

According to still another aspect of the invention, an image display apparatus for displaying an image signal extended and corrected by any one of the above-described image processing apparatuses is provided.

According to still another aspect of the invention, a mobile information device for displaying an image on a liquid crystal display screen using the above-described image display apparatus is provided.

According to still another aspect of the invention, a control program for causing a computer to execute the above-described image processing method is provided.

According to still another aspect of the invention, a computer-readable recording medium having the above-described control program recorded thereon is provided.

In an image processing apparatus according to the present invention, the selection section selects and retrieves a significant part in terms of resolution from a bit steam of an image signal which is input to each pixel of an image display apparatus. The detection section detects a low-frequency part which includes a plurality of consecutive image signals having a first signal value and a plurality of consecutive image signals having a second signal value which is different from the first signal value by a prescribed value. The signal extension section extends and corrects the significant parts of the image signals in a prescribed range of the low-frequency part. The prescribed range includes at least either the plurality of consecutive image signals having the first signal value or the plurality of consecutive image signals having the second signal value. The significant parts of at least either plurality of consecutive image signals are each extended and corrected by being supplemented with a prescribed number of bits, such that the first signal value smoothly changes to the second signal value.

Therefore, the present invention allows the display panel to fully exhibit the display capability thereof. Since the gradation gradually changes in a low-frequency part, the undesirable possibility of the pseudo profile phenomenon that a portion of an image of natural scenery appears as step-like stripes (profiles) is lowered. In addition, the extension is performed on the significant part of an image signal. Therefore, the part subjected to extension is free of insignificant noise or the like which is present in the bit stream of the original image signal. This improves the image quality.

The extension is performed on the image signals in the low-frequency part detected by the detection section by adding a prescribed number of bits by the signal extension section. The part which is not detected by the detection section and thus is not a subject of extension is kept as the original with no gradation correction. In the case where the number of bits obtained as a result of the extension is larger than the number of bits of the original signal, the original signal is supplemented with “0” at the least significant bit(s) such that the original signal has the same number of bits as that of the extended signal. The image processing apparatus according to the present invention does not merely automatically add bits, but adds bits such that the display apparatus can fully exhibit the display capability thereof. Therefore, display defects are prevented such that the brightest display or the darkest display cannot be provided and that conspicuous discrete points are generated.

As described above, an image processing apparatus according to the present invention includes a selection section for selecting and retrieving a significant part in terms of resolution from a bit steam of an image signal which is input to each pixel of an image display apparatus; a detection section for detecting the low-frequency part which includes a plurality of consecutive image signals having a first signal value and a plurality of consecutive image signals having a second signal value which is different from the first signal value by a prescribed value; and a signal extension section for extending and correcting the significant parts of the image signals in a prescribed range of the low-frequency part detected by the detection section. The prescribed range includes the plurality of consecutive image signals having the first signal value and/or the plurality of consecutive image signals having the second signal value. The significant parts of at least either plurality of consecutive image signals are each extended and corrected by being supplemented with a prescribed number of bits, such that the first signal value smoothly changes to the second signal value. Owing to such a structure, the image processing apparatus according to the present invention, with a simple circuit configuration, selects and retrieves a significant bit stream of each color component of a color image, compares signal values of a series of adjacent pixels having a prescribed width, replaces insignificant bit streams with other data, and performs extension of image signals such that one signal value smoothly changes to another signal value. Thus, a signal having a large number of bits can be estimated and recovered. As a result, the color resolution of an image is improved, realizing display of a high quality image. Since only the significant part of an image signal is extended and the insignificant part is not extended, the obtained image is free of noise, or the like, which is present in the bit stream of the original image signal. This improves the image quality.

Thus, the invention described herein makes possible the advantages of providing an image processing apparatus and method for extending and correcting an input image signal so as to fully utilize the display capability of an image display panel and also preventing image quality deterioration caused by noise, an image display apparatus using the same, a mobile information device using the same, a control program for causing a computer to execute the image processing method, and a computer-readable recording medium having the control program recorded thereon.

These and other advantages of the present invention will become apparent to those skilled in the art upon reading and understanding the following detailed description with reference to the accompanying figures.

### BRIEF DESCRIPTION OF THE DRAWINGS

FIG. 1 is a block diagram illustrating a system structure according to one example of a liquid crystal display apparatus of the present invention.

FIG. 2 is a block diagram illustrating an exemplary structure of an image processing apparatus of the liquid crystal display apparatus shown in FIG. 1.

FIG. 3 is a block diagram illustrating an exemplary structure of a detection section of the image processing apparatus shown in FIG. 2.

FIG. 4 is a block diagram illustrating an exemplary structure of a signal extension section of the image processing apparatus shown in FIG. 2.

FIG. 5 is a flowchart illustrating a first half of a basic algorithm of processing performed by the detection section shown in FIG. 3 and the signal extension section shown in FIG. 4.

FIG. 6 is a flowchart illustrating a second half of the basic algorithm of processing performed by the detection section shown in FIG. 3 and the signal extension section shown in FIG. 4.

FIG. 7 is a schematic diagram illustrating an example of pre-extension image signals which are a subject of extension processing performed by the signal extension section shown in FIG. 4.

FIG. 8 is a schematic view of the image signals shown in FIG. 7 which are stored in a line memory of the image processing apparatus shown in FIG. 2.

FIG. 9 is a flowchart illustrating a detailed algorithm of the signal extension processing performed by the signal extension section shown in FIG. 4.

FIG. 10 is a schematic view of an exemplary post-extension image signal obtained as a result of the extension processing performed by the signal extension section shown in FIG. 4.

### DESCRIPTION OF THE PREFERRED EMBODIMENTS

Hereinafter, an image processing apparatus and an image display apparatus, using the same, according to the present invention will be described by way of illustrative examples with reference to the accompanying drawings.

In the following example, an image processing apparatus according to the present invention is included in a liquid crystal display apparatus, corrects a digital image signal having a significant data only at the 6 most significant bits among 8 bits and supplies the corrected signal to a liquid crystal panel. The liquid crystal panel used in this example has 640 (horizontal)×480 (vertical) display pixels.

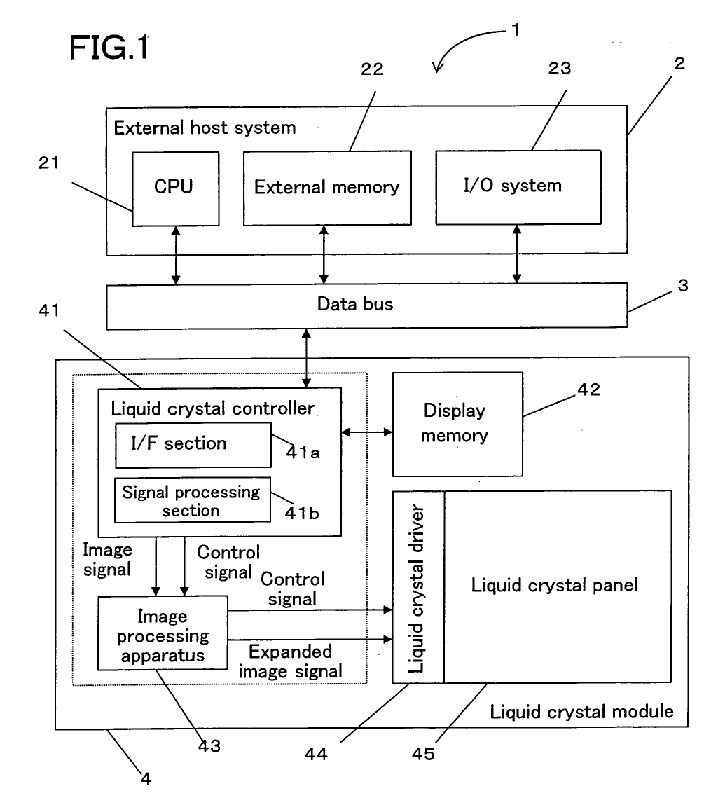

FIG. 1 is a block diagram illustrating a system structure according to one example of the liquid crystal display apparatus of the present invention.

As shown in FIG. 1, a liquid crystal display apparatus 1 has an external host system 2 connected to a liquid crystal display module 4 via a data bus 3.

The external host system 2 includes a CPU (central processing unit) 21, an external memory 22, and an I/O (input/output) system 23, each of which is connected to the data bus 3.

The liquid crystal display module 4 includes a liquid crystal controller 41, a display memory 42, an image processing apparatus 43, a liquid crystal driver 44, and a liquid crystal panel 45. In this example, the image processing apparatus 43 is located between the liquid crystal controller 41 and the liquid crystal driver 44, such that the image processing apparatus 43 can convert an image data output from the liquid crystal controller 41 into an extended image signal by prescribed processing and output the extended image signal to the liquid crystal driver 44.

The liquid crystal controller 41 includes an IF (interface) section 41a and a signal processing section 41b, and the IF section 41a is connected to the data bus 3. The liquid crystal controller 41 is also connected to the display memory 42, and outputs an image signal and a control signal to the image processing apparatus 43 based on display information stored in the display memory 42 and control information.

The image processing apparatus 43 receives the image signal and the control signal from the liquid crystal controller 41 and performs prescribed processing, described later, on the image signal to generate an extended image signal. The extended image signal and the control signal are sent to the liquid crystal driver 44.

Based on the extended image signal and the control signal from the image processing apparatus 43, the liquid crystal driver 44 causes the liquid crystal panel 45 to display an image.

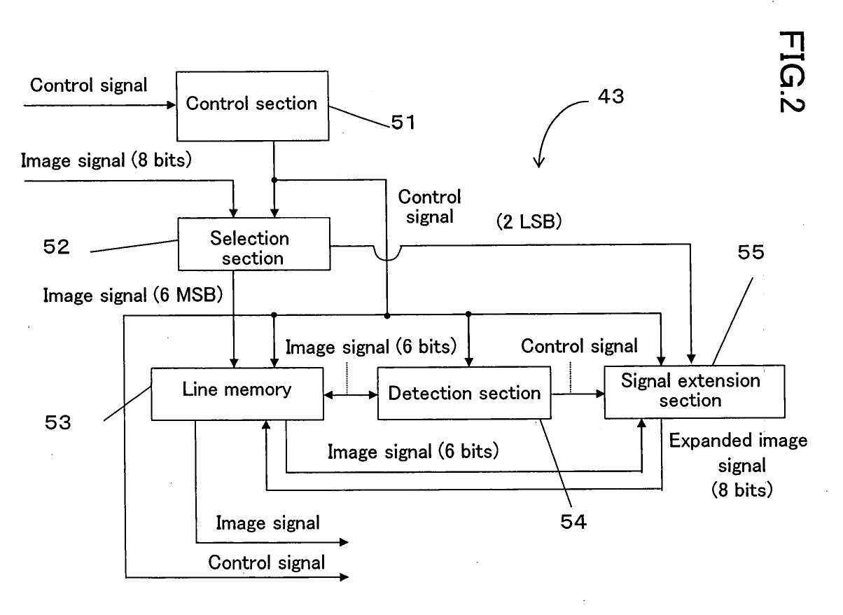

FIG. 2 is a block diagram illustrating a part of the image processing apparatus 43 shown in FIG. 1.

As shown in FIG. 2, the image processing apparatus 43 includes a control section 51, a selection section 52, a line memory 53, a detection section 54, and a signal extension section 55. The detection section 54 and the signal extension section 55 are included in an extension and correction section. The extension and correction section adds a prescribed number of bits (in this example, 2 least significant bits) to the bit stream (selected and retrieved by the selection section 52) of each image signal included in a low-frequency part. The low-frequency part includes a plurality of consecutive image signals having a first signal value and a plurality of consecutive image signals having a second signal value which is different from the first signal value by a prescribed value. The extension and correction is performed such that the first signal value smoothly changes to the second signal value.

The control section 51 receives the control signal which is output from the liquid crystal controller 41. The control signal is then output to each of the selection section 52, the line memory 53, the detection section 54, the signal extension section 55, and the liquid crystal driver 44. The control section 51 controls these sections such that image data obtained as a result of processing performed by each of the selection section 52, the line memory 53, the detection section 54 and the signal extension section 55 is synchronized to the control signal and output to the liquid crystal driver 44.

The selection section 52 selects and retrieves a significant part in terms of resolution (the 6 most significant bits) from a bit stream (8 bits) which represents an image signal which is input to each of pixels of the image display apparatus 1. In more detail, the selection section 52 receives the 8-bit image signal which is output from the liquid crystal controller 41. From the input image signal, the selection section 52 outputs the 6 most significant bits which are significant in terms of resolution to the line memory 53.

The line memory 53 sequentially reads the 6-bit image signals from the selection section 52 line by line, i.e., 640 pixels at a time, in synchronization with the control signal. The line memory 53 also reads an 8-bit extended image signal which has been extended and corrected by the signal extension section 55, and outputs the extended image signal to the liquid crystal driver 44.

The detection section 54 detects the low frequency part of the 6-bit input image signals selected by the selection section 52. As described above, the low frequency part includes a plurality of consecutive 6-bit image signals having a first signal value and also a plurality of consecutive 6-bit image signals having a second signal value. The second signal value is different from the first signal value by a prescribed value. In other words, the detection section 54 reads 6-bit image signals from the line memory 53 and detects a low-frequency part thereof in which the signal value does not smoothly change (discontinuous part).

More specifically, the detection section 54 detects an image pattern which includes a first series of at least two adjacent pixels corresponding to a series of 6-bit image signals having signal value (image data value) L (L: any integer of 0 through 63) and a second series of at least two adjacent pixels corresponding to another series of 6-bit image signals having signal value (L+1) or (L−1). The first series of pixels and the second series of pixels are adjacent to each other. The detection section 54 also stores the position of the first of each series of pixels having an identical signal value and the number of each series of pixels having the identical signal value (width), and outputs the position and the width to the signal extension section 55. Herein, the first series of at least two adjacent pixels will be referred to as the “first series of pixels”, and the second series of at least two adjacent pixels will be referred to as the “second series of pixels”.

The signal extension section 55 performs extension and correction on a prescribed range of the low-frequency part detected by the detection section 54. The prescribed range includes at least either the series of 6-bit image signals having the first signal value or the series of 6-bit image signals having the second signal value. More specifically, the signal extension section 55 adds a prescribed number of bits (2 least significant bits) to at least either the bit streams (6-bit signals) having the first signal value or the bit streams (6-bit signals) having the second signal value, such that the first signal value is smoothly changed to the second signal value. In other words, the 6-bit image signals (having significant 6 bits) which are detected by the detection section 54 as a subject of extension are each supplemented with 2 least significant bits in a step-like manner; and as a result, 8-bit image signals are provided. The original signals are thus corrected. The two bits are added in order to compensate for the discontinuity of the image caused by the insufficiency in the number of bits and to provide smoothness. 6-bit image signals which are not detected as a subject of extension are each supplemented with the 2 least significant bits of the original signals. Thus, here also, 8-bit image signals are provided. In this manner, both the corrected signals and the non-corrected signals have 8 bits. The 8-bit signals obtained by the extension section 55 are written in the line memory 53.

The processing by the detection section 54 and the signal extension section 55 is independently performed for each of R, G and B color components. When the above-described series of processing is finished for one line, the same processing is performed for the next line. When the processing for 480 lines is finished, one image is displayed.

In this example, the signal extension is performed when a series of at least two adjacent pixels having a first signal value, and a series of at least two adjacent pixels having a second signal value which is different from the first signal value by 1, are detected. The threshold values for, for example, the difference between the signal values and the number of adjacent pixels having the same signal value can be freely set.

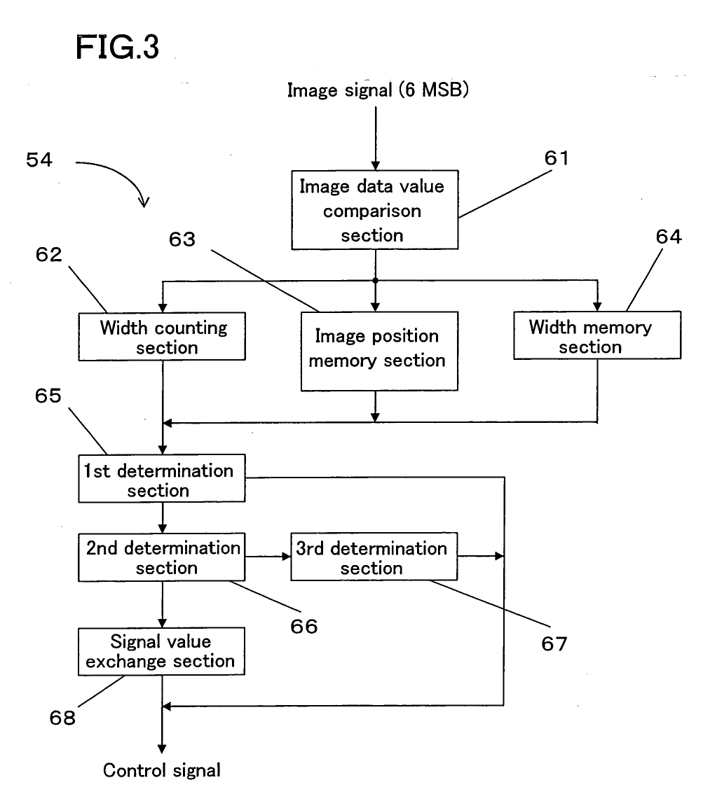

Next, a detailed structure of the detection section 54 shown in FIG. 2 will be described with reference to FIG. 3.

As shown in FIG. 3, the detection section 54 includes an image data value comparison section (signal value comparison section) 61, a width counting section 62, an image position memory section 63, a width memory section 64, first through third determination sections 65 through 67, and a signal value exchange section 68.

The image data value comparison section 61 is connected to the line memory 53. The image data value comparison section 61 compares the data values (signal values) of pixels adjacent in the horizontal direction (or the lateral direction) of an image data which is read from the line memory 53, so as to determine whether the data values are equal to each other or not.

The width counting section 62 is connected to the image data value comparison section 61. When the image data value comparison section 61 determines that the series of adjacent pixels have the same data value, the width counting section 62 adds 1 to the width of the adjacent pixels and counts the resultant width.

The image position memory section 63 is connected to the image data value comparison section 61. When the image data value comparison section 61 determines that the adjacent pixels have the same data value, the image position memory section 63 stores the position of the first pixel of the series of adjacent pixels.

The width memory section 64 is connected to the image data value comparison section 61. When the image data value comparison section 61 determines that the series of pixels having the same data value is terminated, the width memory section 64 stores the width (number) of the series of pixels.

The first determination section 65 is connected to each of the width counting section 62, the pixel position memory section 63 and the width memory section 64. The first determination section 65 determines whether or not the distance between the position of the first pixel of a first series of pixels and the position of the first pixel of a second series of pixels adjacent to the first series of pixels equals the width of the first series of pixels.

The second determination section 66 is connected to the first determination section 65. The second determination section 66 determines whether or not the image data value of the first series of pixels is larger by one than the image data value of the second series of pixels.

The third determination section 67 is connected to the second determination section 66. The third determination section 67 determines whether or not the image data value of the first series of pixels is smaller by one than the image data value of the second series of pixels.

When the results of determination obtained by the first determination section 65 and the second determination section 66 are both “yes”, the signal value exchange section 68 exchanges symmetrical right half and left half of the image data in the line memory 53 which is a subject of extension.

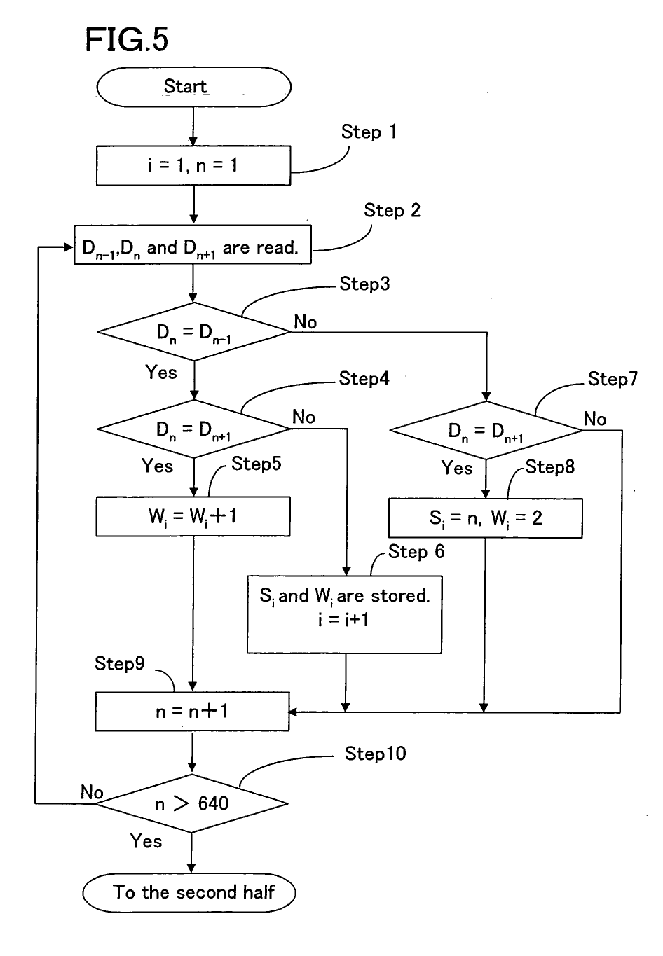

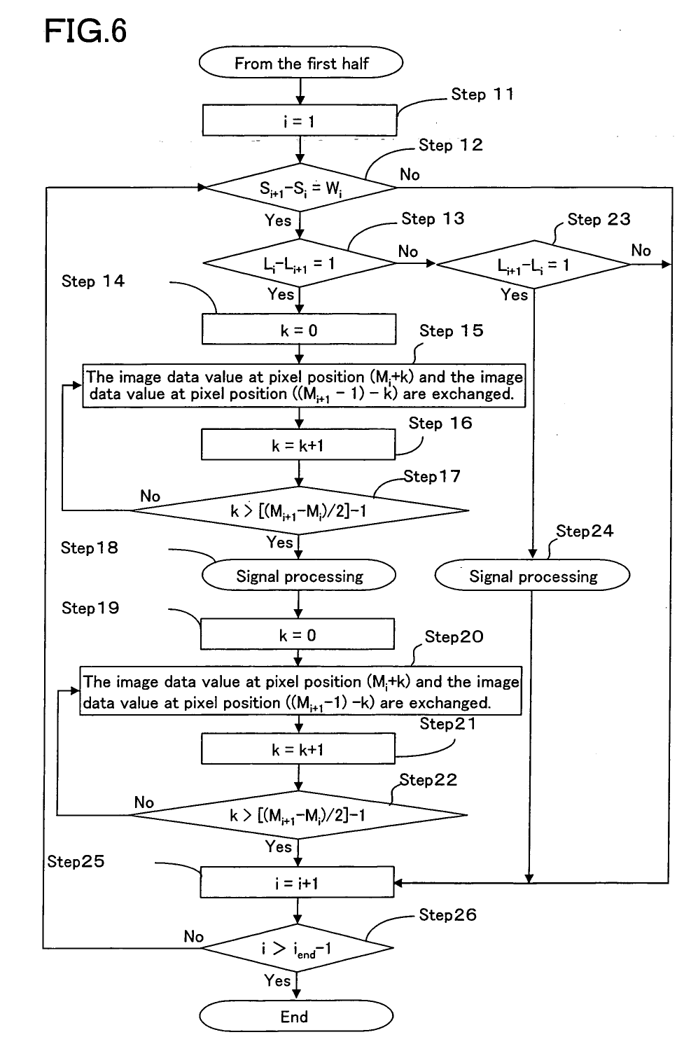

In the extension and correction shown in FIGS. 5 and 6, the image data value comparison section 61, the width counting section 62, the image position memory section 63 and the width memory section 64 perform the first half of the processing, which is shown in FIG. 5. The first determination section 65, the second determination section 66, the third determination section 67, and the signal exchange section 68 perform the second half of the processing, which is shown in FIG. 6.

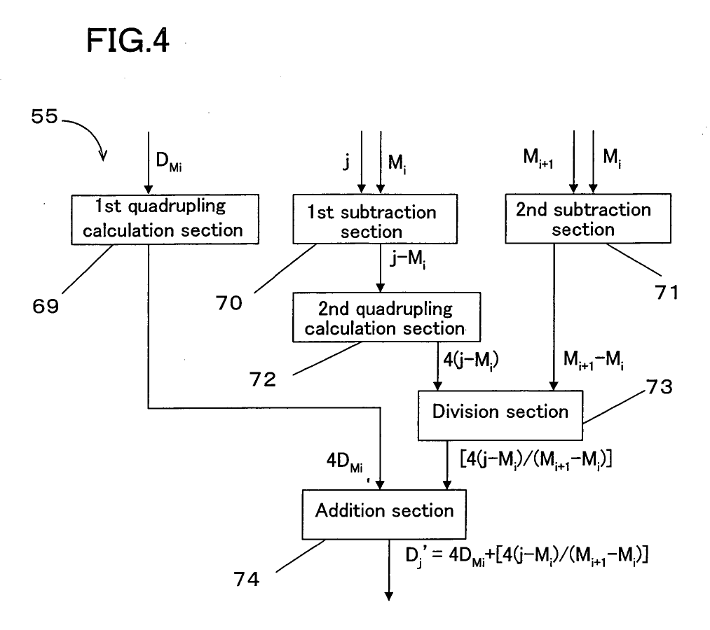

A detailed structure of the signal extension section 55 shown in FIG. 2 will be described with reference to FIG. 4.

As shown in FIG. 4, the signal extension section 55 includes a first quadrupling calculation section 69, a first subtraction section 70, a second subtraction section 71, a second quadrupling calculation section 72, a division section 73 and an addition section 74.

The first quadrupling calculation section 69 has a 2-bit bit shift circuit, and quadruples an input value of an input signal using the bit shift circuit.

The first subtraction section 70 and the second subtraction section 71 each have a subtraction circuit and subtract an input value of an input signal using the subtraction circuit.

The second quadrupling calculation section 72 has a 2-bit bit shift circuit, and quadruples an input value of an input signal using the bit shift circuit.

The division section 73 has a division circuit and divides an input value of an input signal using the division circuit.

The addition section 74 has an addition circuit and adds an input value of an input signal using the addition circuit.

With reference to FIGS. 5 and 6, a basic algorithm of the processing performed by the detection section 54 and the signal extension section 55 will be described. FIG. 5 shows a first half of the processing performed by the detection section 54 and the signal extension section 55, and FIG. 6 shows a second half of the processing.

In FIGS. 5 and 6, “n” represents a number given to each pixel arranged in one line in accordance with the order of the position thereof. In this example, there are 640 pixels in one line, and “n” is a natural number of 1 through 640. The image data value of each pixel in one line is represented by D₁; D₂, . . . , D₆₄₀. The value of the subscript numeral corresponds to the value of “n”. “i” represents a number given to each series of at least two adjacent pixels having the same image data value in the order of the position thereof from one end of one line (1≦Sᵢ<n). Sᵢ represents the position of the first pixel of a series of pixels having the same image data value. Wᵢ represents the number of pixels of such a series of pixels. For example, where the image data value is D₁=D₂=D₃, D₄=D₅, S₁=1 and W₁=3; S₂=4 and W₂=2.

The processing by the detection section 54 and the signal extension section 55 is performed as follows.

First, in step 1, i=1 and n=1 are set.

In step 2, the image data value comparison section 61 reads image data Dₙ₋₁, Dₙ and Dₙ₊₁.

In step 3, the image data value comparison section 61 compares image data Dₙ and image data Dₙ₋₁ which is adjacent to, and before, image data Dₙ.

When it is determined that the value of image data Dₙ is equal to the value of image data Dₙ₋₁ in step 3, the processing advances to step 4, where the image data value comparison section 61 compares image data Dₙ and image data Dₙ₊₁ which is adjacent to, and after, image data Dₙ.

When it is determined that the value of image data Dₙ is different from the value of image data Dₙ₋₁ in step 3, the processing advances to step 7, where the image data value comparison section 61 compares image data Dₙ and image data Dₙ₊₁ which is adjacent to, and after, image data Dₙ.

When it is determined that the value of image data Dₙ is equal to the value of image data Dₙ₊₁ in step 4, the values of image data Dₙ₋₁, Dₙ and Dₙ₊₁ are all equal. The processing advances to step 5, where the width counting section 62 adds 1 to width value W₁ stored in the width memory section 64. The processing advances to step 9.

When it is determined that the value of image data Dₙ is different from the value of image data Dₙ₊₁ in step 4, the values of image data D₁₋₁ and Dₙ are equal to each other but the values of image data Dₙ and Dₙ₊₁ are different from each other. Pixel position n indicates the position at which the series of pixels having the same image data value is terminated. Thus, in step 6, Sᵢ and Wᵢ are stored, and i is updated into (i+1).

When it is determined that the value of image data Dₙ is different from the value of image data Dₙ₋₁ in step 3, and it is determined that the value of image data Dₙ is equal the value of image data Dₙ₊₁ in step 7, pixel position n indicates the position at which the series of pixels having the same image data value starts. Thus, in step 8, Sᵢ=n is stored in the image position memory section 63 and Wᵢ=2 is stored in the width memory section 64. Then, the processing advances to step 9.

When it is determined that the value of image data Dₙ is different from the value of image data Dₙ₊₁ in step 7, the values of image data Dₙ₋₁, Dₙ and Dₙ₊₁ are all different. There is no series of pixels having the same image data value. Thus, the processing advances to step 9 with nothing being stored in the image position memory section 63 or the width memory section 64.

In step 9, n is updated into (n+1). In step 10, it is determined whether n exceeds 640 or not. When it is determined that n does not exceed 640, the processing returns to step 2, and the operation in steps 2 through 10 is repeated for (n+1). When n exceeds 640, the processing advances to step 11 in FIG. 6.

The operation in steps 2 through 10 is repeated for n=1 through 640.

In the second half of the processing shown in FIG. 6, it is determined whether a specific part of the pixels is a subject of extension or not using start position Sᵢ and width Wᵢ stored in step 6. When the specific part is determined to be a subject of extension, that part is extended.

In the following description, the image data value of the pixel at Sᵢ is Lᵢ. The pixel position at the center between Sᵢ and Sᵢ+Wᵢ is Mᵢ. The pixel position at the center between Sᵢ₊₁ and Sᵢ₊₁+Wᵢ₊₁ is Mᵢ₊₁. More accurately, Mᵢ and Mᵢ₊₁ are pixel positions represented as follows:
Mᵢ=Sᵢ+[Wᵢ/2]
Mᵢ₊₁=Sᵢ₊₁+[Wᵢ₊₁/2]

“[ ]” is the Gauss symbol, and [a] represents the maximum integer not exceeding “a”.

In step 11, i=1 is set.

In step 12, it is determined whether or not Sᵢ₊₁−Sᵢ=Wᵢ. When it is determined that Sᵢ₊₁−Sᵢ=Wᵢ, the processing advances to step 13. When it is determined that Sᵢ₊₁−S≠Wᵢ, the processing advances to step 25.

In step 13, it is determined whether or not Lᵢ−Lᵢ₊₁=1. When it is determined that Lᵢ−Lᵢ₊₁=1, the processing advances to step 14. When it is determined that Lᵢ−Lᵢ₊₁≠1, the processing advances to step 23.

In step 23, it is determined whether or not Lᵢ₊₁−Lᵢ=1. When it is determined that Lᵢ₊₁−Lᵢ=1, the processing advances to step 24, where the signal extension section 55 performs signal extension. When it is determined that Lᵢ₊₁−Lᵢ≠1, the processing advances to step 25.

In step 14, k=0 is set. k is an integer of 0through ([(Mᵢ₊₁−Mᵢ)/2]−1).

Next, in step 15, the image data value of pixel position (Mᵢ+k) and the image data value of pixel position ((Mᵢ₊₁−1)−k) are exchanged. Then, the processing advances to step 16, where k is updated into (k+1).

Then, in step 17, it is determined whether or not the updated k (=k+1) exceeds ([(Mᵢ+1−Mᵢ)/2]−1). When it is determined that updated k does not exceed ([(Mᵢ₊₁−Mᵢ)/2]−1), the processing returns to step 15, and the operation in steps 15 through 17 is repeated for (k+1). When it is determined that updated k exceeds ([(Mᵢ₊₁−Mᵢ)/2]−1), the processing advances to step 18. The operation in steps 15 through 17 is repeated for k=0 through ([(Mᵢ₊₁−Mᵢ)/2]−1).

Then, in step 18, the signal extension section 55 performs signal extension.

Then, in step 19, k=0 is set. k is an integer of 0 through ([(Mᵢ₊₁−Mᵢ)/2]−1).

In step 20, the image data value of pixel position (Mᵢ+k) and the image data value of pixel position ((Mᵢ₊₁−1)−k) are exchanged. Then, the processing advances to step 21, where k is updated into (k+1).

Then, in step 22, it is determined whether or not the updated k (=k+1) exceeds ([(Mᵢ₊₁−Mᵢ)/2]−1). When it is determined that updated k does not exceed ([(Mᵢ₊₁−Mᵢ)/2]−1), the processing returns to step 20, and the operation in steps 20 through 22 is repeated for (k+1). When it is determined that updated k exceeds ([(Mᵢ₊₁−Mᵢ)/2]−1), the processing advances to step 25. The operation in steps 20 through 22 is repeated for k=0 through ([(Mᵢ₊₁−Mᵢ)/2]−1).

In step 25, i is updated into (i+1).

In step 26, it is determined whether or not the updated i (=i+1) exceeds i_{end}−1. i_{end} represents the maximum of the values of i which are set in the first half of the processing shown in FIG. 5. When it is determined that the updated i does not exceed i_{end}−1, the processing returns to step 12, and the operation in steps 12 through 26 is repeated for (i+1). When it is determined that the updated i exceeds i_{end}−1, the processing is terminated.

Thus, the operation in steps 12 through 26 is repeated for i=1 through i_{end}−1.

The second half of the processing performed by the detection section 54 and the signal extension section 55 will be described more specifically.

Start position Sᵢ and width Wᵢ (i=1, 2, . . . i_{end}) are stored by the first half of the processing shown in FIG. 5. In the second half of the processing, only image signals corresponding to a range of pixels in which Sᵢ₊₁−Sᵢ=Wᵢ and further Lᵢ−Lᵢ₊₁=1, and image signals corresponding to a range of pixels in which Sᵢ₊₁−Sᵢ=Wᵢ and further Lᵢ₊₁−Lᵢ=1, are extended. Image signals of a range of pixels in which the difference between continuous image data values Lᵢ and Lᵢ₊₁ is ±2 or greater are not extended. In actuality, extension is performed on image signals corresponding to a range of pixels having pixel positions Mᵢ through (Mᵢ₊₁−1).

When Sᵢ₊₁−Sᵢ=Wᵢ and further Lᵢ₊₁−Lᵢ=1, the image signals are extended by the signal extension section 55 with no other processing. When Sᵢ₊₁−Sᵢ=Wᵢ and further Lᵢ−Lᵢ₊₁=1, the image data is exchanged as follows. The image data at pixel position Mᵢ is exchanged with the image data at pixel position (Mᵢ₊₁−1), image data at pixel position (Mᵢ+1) is exchanged with the image data at pixel position (Mᵢ₊₁−2), and image data at pixel position (Mᵢ+2) is exchanged with the image data at pixel position (Mᵢ₊₁−3). In the same manner, image data at pixel position (Mᵢ+[(Mᵢ₊₁−Mᵢ)/2]−1) is exchanged with the image data at pixel position (M₁₊₁−[(Mᵢ₊₁−Mᵢ)/2] until all the data in the left half is exchanged with all the data in the right half which is symmetrical with the left half. Then, the resultant data is extended. After that, the same processing is performed to return the image data to the original data.

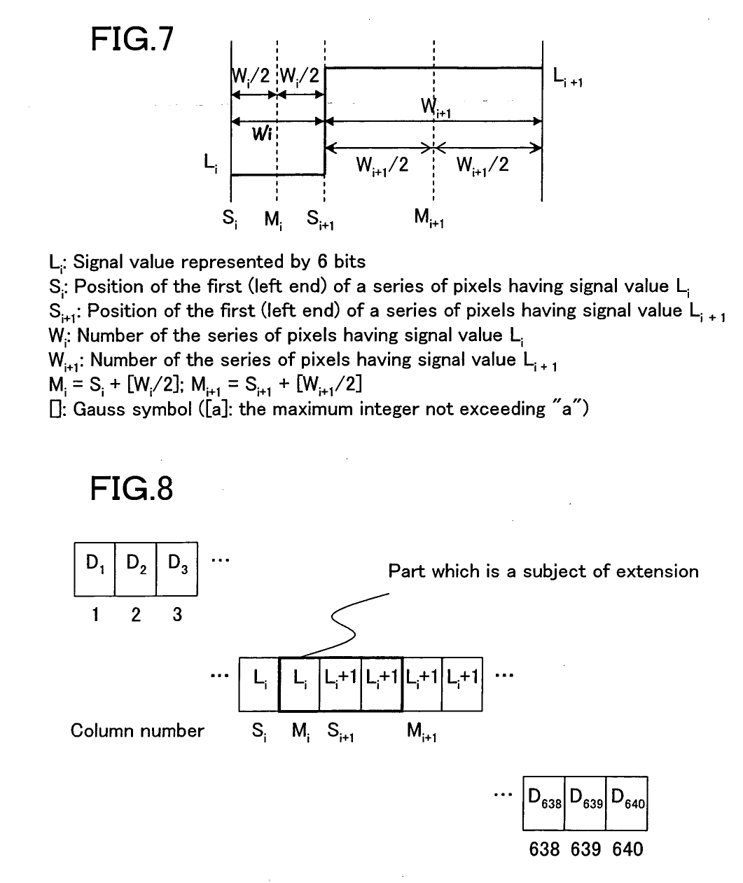

FIG. 7 schematically shows an example of pre-extension image signals which are a subject of signal extension by the signal extension section 55, i.e., the 6 most significant bits of 8-bit original signals.

In the example shown in FIG. 7, pixels of signal value Lᵢ represented by 6 bits are consecutively arranged for the width of Wᵢ from start position Sᵢ. This series of pixels are immediately followed by pixels of signal value Lᵢ₊₁(Lᵢ+1) which are consecutively arranged for the width of Wᵢ₊₁ from start position Sᵢ₊₁(=Sᵢ+Wᵢ). As shown in FIG. 8, such data is stored in the line memory 53 in parallel lines.

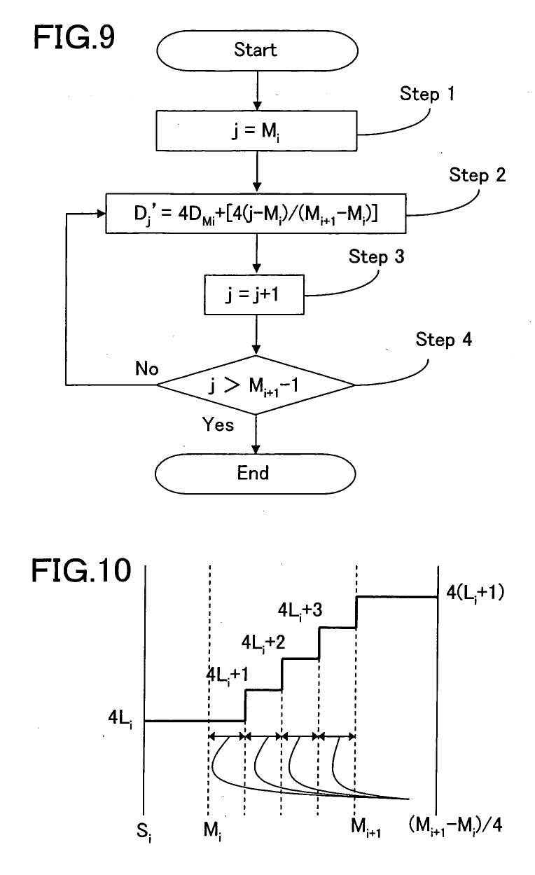

The signal extension performed by the signal extension section 55 will be described in more detail with reference to FIGS. 4 and 9.

FIG. 9 is a flowchart illustrating an algorithm of signal extension processing performed by the signal extension section 55.

In the signal extension processing, a 6-bit signal is extended to an 8-bit signal. Specifically, the following processing is performed. Signal levels Lᵢ and (Lᵢ+1) (Lᵢ: 0 through 63) both represented by 6 bits are 4Lᵢ and (4Lᵢ+1) (4Lᵢ: 0 through 255) in an 8-bit representation. Each of the image signals represented by 6 bits is supplemented with 2 bits at the LSBs to form an 8-bit image signal. More specifically, 2 bits are supplemented such that the drastic change from signal value 4Lᵢ of the pixels Mᵢ through (Sᵢ₊₁−1) to signal value 4(Lᵢ+1) of the pixels Sᵢ₊₁ through (Mᵢ₊₁−1) becomes a gradual, smooth change from 4Lᵢ to (4Lᵢ+1) to (4Lᵢ+2) to (4Lᵢ+3) to 4(Lᵢ+1). Each step of change is made by width (i.e., number of pixels) [(Mᵢ₊₁−Mᵢ)/4]. Thus, each image signal has 8 bits. As a result, a discontinuous gradation change from signal level Lᵢ to (Lᵢ+1) due to the insufficiency in the number of bits is corrected to be a smooth, linear gradation change as shown in FIG. 10.

In the following description, Dⱼ represents the 6-bit image data value at pixel position j, and Dⱼ′ represents the post-extension 8-bit image data value at pixel position j.

As shown in FIG. 9, the signal extension processing performed by the signal extension section 55 starts in step 1, where j=Mᵢ is set.

In step 2, extension is performed on the pixel at pixel position j. Namely, 6-bit image data Dⱼ at pixel position j is extended to provide 8-bit image data Dⱼ′.

The signal extension processing will be described in more detail with reference to FIG. 4. First, the first quadrupling calculation section 69 receives image data D_{Mi} at pixel position Mᵢ and quadruples image data D_{Mi} to provide 4D_{Mi}.

The first subtraction section 70 receives pixel positions j and Mᵢ, and performs the subtraction (j−Mᵢ).

The second subtraction section 71 receives pixel positions Mᵢ₊₁ and Mᵢ, and performs the subtraction (Mᵢ₊₁−Mᵢ).

The result of the subtraction by the first subtraction section 70, i.e., (j−Mᵢ) is sent to the second quadrupling calculation section 72. The second quadrupling calculation section 72 quadruples (j−Mᵢ) to provide 4(j−Mᵢ).

The division section 73 receives 4(j−Mᵢ) obtained by the second quadrupling calculation section 72 and (Mᵢ₊₁−Mᵢ) obtained by the second subtraction section 71, and performs division to provide [4(j−Mᵢ)/(M₊₁−Mᵢ)].

The addition section 74 receives 4D_{Mi} obtained by the first quadrupling calculation section 69 and [4(j−Mᵢ)/(Mᵢ₊₁−Mᵢ)] obtained by the division section 73, and adds these values to provide extended 8-bit image data Dⱼ′=4D_{Mi}+[4(j−Mᵢ)/(Mᵢ₊₁−Mᵢ)]. D_{Mi} is the value of the 6-bit image data at Mᵢ. In the case where no data exchange is performed, i.e., in the case of (Lᵢ₊₁−Lᵢ=1), D_{Mi}=Lᵢ. In the case where data exchange is performed, i.e., in the case of (Lᵢ−Lᵢ₊₁=1), D_{Mi}=Lᵢ₊₁.

When the signal extension processing for j is finished, j is updated into j+1 in step 3 (FIG. 9).

In step 4, it is determined whether or not the updated j(=j+1) exceeds (Mᵢ₊₁−1). When it is determined that j does not exceed (Mᵢ₊₁−1), the processing returns to step 2, and the operation of steps 2 through 4 is performed for (j+1). When it is determined that j exceeds (Mᵢ₊₁−1), the signal extension processing is terminated.

In the image processing apparatus according to this example of the present invention, the detection section 54 detects a range of pixels in which there are a first series of adjacent pixels having the same image data value L, and this series of adjacent pixels is adjacent to a second series of adjacent pixels having image data value (L+1) or (L−1). The detection section 54 also stores start position Sᵢ of, and the width Wᵢ of, the first series of pixels. The signal extension section 55 extends and corrects the 6-bit image data into an 8-bit image data using start position Sᵢ and width Wᵢ stored by the detection section 54. Therefore, the display capability of the liquid crystal panel 45 can be fully utilized. The problem of discontinuous display caused by the insufficiency in the number of bits is solved, and a smooth, linear gradation change can be provided. In addition, since the extension and correction processing is performed on the significant part of the bit streams of the image signals, the part subjected to extension is free of insignificant noise or the like which is present in the bit streams of the original image signals. This improves the image quality.

In FIG. 1, the image processing apparatus 43 is located between the liquid crystal controller 41 and the liquid crystal driver 44. Alternatively, the image processing apparatus 43 may be located at another position, for example, inside the liquid crystal controller 41.

In the case where the image processing apparatus 43 is located inside the liquid crystal controller 41, the image processing apparatus 43 and the signal processing section 41b may be formed of separate circuits or may be integrated into a 1-chip microprocessor. In the latter case, multi-purpose processing is possible.

In the case where the image processing apparatus 43 and the signal processing section 41b are integrated into a 1-chip microprocessor, the control program shown in FIGS. 5, 6 and 9 and data therefor may be stored in the external memory 22 as a computer-readable recording medium of the external host system 2. The external host system 2 may control the CPU (control section) in the liquid crystal controller 41 to execute the control program. The control program may be stored in a built-in memory of the liquid crystal controller 41 or the liquid crystal driver 44.

The computer-readable recording medium may be a compact mobile memory device such as any of various types of IC memories, an optical disc (e.g., a CD), or a magnetic recording medium (e.g., an FD). The control program is stored in a RAM as a work memory in the liquid crystal controller 41 or the image processing apparatus 43, and is executable by the CPU (control section) therein.

In this example, the image processing apparatus according to the present invention is used in a liquid crystal display apparatus for displaying a color image using a combination of R, G and B color components. The image processing apparatus according to the present invention is not limited to use in such a liquid crystal display apparatus, and is also usable in a liquid crystal display apparatus for displaying a monochromatic image. The image processing apparatus according to the present invention is also usable in, for example, an ELD (electroluminescence display) and a PDP (plasma display panel).

The image processing apparatus according to the present invention is usable in, for example, a cellular phone device or a PDA as a mobile information device. The effect of the present invention to provide high display quality is exhibited by an image displayed on the liquid crystal display screen of such a mobile information device.

In this example, data of pixels adjacent in the horizontal direction (the direction in which the image signal is sequentially transmitted on the image display screen) is extended and corrected. In the case where the image processing apparatus includes a section for storing vertical lines such as a frame memory or the like, data of pixels adjacent in the vertical direction (the direction perpendicular to the horizontal direction) can be extended and corrected. In the case where the image processing apparatus includes a section for storing image data which has been subjected to detection, extension and correction on a line-by-line basis, data of pixels adjacent in the vertical direction and oblique directions can be extended and corrected in combination with data of pixels adjacent in the horizontal direction. It is also possible to extend the image data in a curved manner (e.g., in an upward curve or a downward curve) in addition to linear extension. With such omni-directional extension and correction processing, a more natural-looking image with a higher degree of freedom can be provided.

In this example, the selection section 52 selects and retrieves a significant part in terms of resolution (the 6 most significant bits) from a bit stream (8 bits) which represents an image signal input to each of pixels of the image display apparatus 1, and the signal extension section 55 extends the 6-bit data into an 8-bit data. The number of bits of an input image signal and the number of bits selected and retrieved by the selection section 52 are not limited to 8 and 6. Alternatively, the selection section 52 may select and retrieve the 6 most significant bits in terms of resolution from a 10-bit data of an input image signal, and the signal extension section 55 may extend the 6-bit data by 4 bits to provide a 10-bit data. The selection section 52 may select and retrieve the 5 most significant bits in terms of resolution from a 6-bit data of an input image signal, and the signal extension section 55 may extend the 5-bit data by 3 bits to provide an 8-bit data. The effect of the present invention can be exhibited with various combinations of the number of bits for the selection processing by the selection section 52 and the signal extension processing by the signal extension section 55.

In this example, the signal extension section 55 extends a portion extending from the center of a series of pixels having the first signal value to the center of a series of pixels having the second signal value. The present invention is not limited to such a manner of processing. It is sufficient as long as the signal extension section 55 extends a portion including at least one pixel in the series of pixels having the first signal value and at least one pixel in the series of pixels having the second signal value, where the at least one pixels are located before and after the point of discontinuity (point of change) at which the first signal value is changed to the second signal value, while the point of discontinuity is at the center of the bit stream which is subjected to extension.

In the field of image processing apparatuses and methods for correcting an image signal by estimating insignificant bit streams from significant bit streams of the image signal and replacing the insignificant bit streams with another data through calculations, and also in the field of image display apparatuses using the same, the present invention provides an image processing apparatus for extending and correcting an input image signal such that the display capability of a display panel of the image display apparatus is fully utilized.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

1. An image processing apparatus, comprising:
a selection section for selecting and retrieving a significant part in terms of resolution from a bit steam of an image signal which is input to each pixel of an image display apparatus; and
an extension and correction section for extending and correcting the significant parts of the image signals selected by the selection section in a low-frequency part, which includes a plurality of consecutive image signals having a first signal value and a plurality of consecutive image signals having a second signal value which is different from the first signal value by a prescribed value, wherein the significant parts are each extended and corrected by being supplemented with a prescribed number of bits, such that the first signal value smoothly changes to the second signal value.

2. An image processing apparatus according to claim 1, wherein the extension and correction section includes:
a detection section for detecting the low-frequency part which includes the plurality of consecutive image signals having the first signal value and the plurality of consecutive image signals having the second signal value which is different from the first signal value by the prescribed value; and
a signal extension section for extending and correcting the significant parts of the image signals in a prescribed range of the low-frequency part detected by the detection section, the prescribed range including at least either the plurality of consecutive image signals having the first signal value or the plurality of consecutive image signals having the second signal value, wherein the significant parts of at least either the plurality of consecutive image signals having the first signal value or the plurality of consecutive image signals having the second signal value are each extended and corrected by being supplemented with a prescribed number of bits, such that the first signal value smoothly changes to the second signal value.

3. An image processing apparatus according to claim 2, wherein the detection section includes:
a signal value comparison section for comparing signal values corresponding to a series of adjacent pixels and determining whether or not the signal values are equal to each other;
an image position memory section for, when the signal value comparison section determines that the signal values are equal to each other, storing position information on a position of the first pixel of the series of adjacent pixels corresponding to the same signal value; and
a width memory section for, when the signal value comparison section determines that the signal values are equal to each other, storing the number of the pixels of the series of adjacent pixels corresponding to the same signal value.

4. An image processing apparatus according to claim 3, wherein the detection section determines whether or not a given image signal is subject of extension and correction by determining whether or not a distance between a position of the first pixel of a first series of adjacent pixels corresponding to the first signal value and a position of the first pixel of a second series of adjacent pixels corresponding to the second signal value is equal to the number of pixels of the first series of adjacent pixels.

5. An image processing apparatus according to claim 4, wherein, when the detection section determines that the given image signal is not a subject of extension and correction, the signal extension section supplements the significant part of the given image signal with a prescribed number of bits having a value of an insignificant part of the input image signal and/or having a fixed value.

6. An image processing apparatus according to claim 2, wherein in the low-frequency part detected by the detection section, the first signal value is different from the second signal value by 1.

7. An image processing apparatus according to claim 2, wherein the extension and correction section performs extension and correction on image signals from the center of the plurality of consecutive image signals having the first signal value to the center of the plurality of consecutive image signals having the second signal value.

8. An image processing apparatus according to claim 2, wherein the extension and correction section performs extension and correction on image signals in a range which includes at least an image signal having the first signal value and an image signal having the second signal value, which are located before and after a point of change at which the first signal value changes to the second signal value.

9. An image processing apparatus according to claim 8, wherein the extension and correction section performs extension and correction on image signals such that the point of change at which the first signal value changes to the second signal value is the center of a bit stream to be extended and corrected.

10. An image processing apparatus according to claim 1, wherein the prescribed number of bits is either two bits, three bits or four bits.

11. An image processing apparatus according to claim 2, wherein the signal extension section performs extension and correction such that the first signal value changes to the second signal value linearly or in a curved manner.

12. An image processing apparatus according to claim 1, wherein the plurality of consecutive image signals having the first signal value and the plurality of consecutive image signals having the second signal value are arranged in at least one of a horizontal direction in which the image signals are transmitted on an image display screen of the image display apparatus, a vertical direction perpendicular to the horizontal direction, and an oblique direction.

13. An image processing apparatus according to claim 1, wherein the significant part has a number of gradation bits which is smaller than the number of gradation bits of the image display apparatus.

14. An image processing method, comprising the steps of:
selecting and retrieving a significant part in terms of resolution from a bit steam of an image signal which is input to each pixel of an image display apparatus;
detecting a low-frequency part which includes a plurality of consecutive image signals having a first signal value and a plurality of consecutive image signals having a second signal value which is different from the first signal value by a prescribed value; and
extending and correcting the significant parts of the image signals in a prescribed range of the low-frequency part, the prescribed range including at least either the plurality of consecutive image signals having the first signal value or the plurality of consecutive image signals having the second signal value, wherein the significant parts of at least either the plurality of consecutive image signals having the first signal value or the plurality of consecutive image signals having the second signal value are each extended and corrected by being supplemented with a prescribed number of bits, such that the first signal value smoothly changes to the second signal value.

15. An image display apparatus for displaying an image signal extended and corrected by an image processing apparatus according to claim 1.

16. A mobile information device for displaying an image on a liquid crystal display screen using an image display apparatus according to claim 15.

17. A control program for causing a computer to execute an image processing method according to claim 14.

18. A computer-readable recording medium having a control program according to claim 17 recorded thereon.
